(19) United States
(12) Patent Application Publication
(10) Pub. No.: US 2006/0203853 A1
(43) Pub. Date: Sep. 14, 2006

(54) Apparatus and methods for video synchronization by parsing time stamps from buffered packets

(76) Inventor: Ji Hee Hwang, Gyeonggi-do (KR)

Correspondence Address: MYERS BIGEL SIBLEY & SAJOVEC, PO BOX 37428, RALEIGH, NC, 27627, US

(21) Appl. No.: 11/358,842

(22) Filed: Feb. 21, 2006

(30) Foreign Application Priority Data
Mar. 14, 2005 (KR) 2005-21067

(51) Int. Cl. H04L 12/28; H04J 3/06

(52) U.S. Cl. 370/503; 370/395.62

(57) ABSTRACT

A plurality of packets of the coded stream, e.g., an MPEG Packetized Elementary Stream (PES) is stored in a buffer. A stored packet is retrieved from the buffer and parsed to recover a time stamp. The recovered time stamp is compared to a time reference, such as a system time clock (STC). Decoding of data in the retrieved packet is controlled responsive to the comparison of the recovered time stamp to the time reference. Retrieval of the stored packet may include retrieving the stored packet from the buffer responsive to a preceding comparison of the time reference to a time stamp of a packet previously retrieved from the buffer.

### CROSS REFERENCE TO RELATED APPLICATION

This application claims priority under 35 USC § 119 to Korean Patent Application No. P2005-0021067, filed Mar. 14, 2005, the disclosure of which is herein incorporated by reference in its entirety.

### BACKGROUND OF THE INVENTION

The present invention relates to digital compression techniques and, more particularly, to apparatus and methods for synchronized decoding of compressed digital information.

The MPEG-2 standard for compressing moving pictures has been adopted for digital television (DTV) broadcasting systems. DTV receivers applying this standard have been developed. MPEG-2 may also be used in a variety of other video and audio transmission applications.

In a typical MPEG-2 transmission, an Elementary Stream (ES), e.g., an audio, video and/or data stream, is packetized to form a Packetized Elementary Stream (PES), which, in turn, may be multiplexed with other Packetized Elementary Streams in a Transport Stream (TS) that is subsequently transmitted over a communications medium, e.g., wireless, wireline or optical medium. For video applications, a Packetized Elementary Stream may include a Picture Start Code (PSC) for marking the start of image data for a picture and one or more types of time stamps. These time stamps may include a Decoding Time Stamp (DTS) indicating a relative time for decoding an encoded picture and/or a Presentation Time Stamp (PTS) indicating a display time for an encoded picture. Generally, both a DTS and a PTS are transmitted for Intra-coded pictures (I-pictures) and Predictive-coded pictures (P-pictures), but only a PTS is transmitted for Bidirectionally predictive-coded pictures (B-pictures). In some conventional decoders, Elementary Stream data and time stamps are extracted from a Packetized Elementary Stream, with the extracted Elementary Stream data being stored in a buffer and the extracted time stamps being stored in a memory that associates the time stamps with pointers to the buffer that are used to selectively retrieve the Elementary Stream data for decoding.

A typical receiver configuration implementing such a process is shown in FIG. 1. A transport stream demultiplexer unit 10 includes a transport stream depacketizer 11 that receives a Transport Stream and demultiplexes it to produce a constituent Packetized Elementary Stream. A PES demultiplexer 12 parses headers of the packets of the Packetized Elementary Stream, stores extracted header information (including time stamps) in a memory 40 and stores extracted Elementary Stream data in an ES buffer 20. A PTS/DTS extractor 50 extracts and stores time stamps from the header information stored in the memory 40. The extracted time stamps are used in a comparison/control unit 60. The time stamps are used for synchronization when the decoder 30 reads and decodes the Elementary Stream data stored in the buffer 20. The comparison/control unit 60 compares a reference time to a System Time Clock (STC) with the stored time stamps and responsively generates control signals for decoding and display of the buffered Elementary Stream data. The decoder 30, responsive to these control signals, decodes the video data the Elementary Stream data stored in the buffer 20, and provides the decoded data to a display device 70 for generation of images.

In the system of FIG. 1, time stamps are stored in a memory 40 that associates the respective time stamps to with respective ES data storage locations in the buffer 20 using pointers, as shown in FIG. 2 To control provision of ES data from the buffer 20 to the decoder 30, the memory 40 is searched to compare the stored time stamps to the System Time Clock to identify a pointer to the buffer 20 that stores the appropriate ES data to be decoded. A similar approach is shown in U.S. Pat. No. 6,091,769 to Moon. An alternative approach using parsing and time stamp analysis of incoming packets is described in U.S. Pat. No. 5,667,980 to Naoe.

### SUMMARY OF THE INVENTION

Some embodiments of the present invention provide methods of processing a packetized coded stream, such as an MPEG video or audio Packetized Elementary Stream (PES). A plurality of packets of the coded stream is stored in a buffer. A stored packet is retrieved from the buffer and parsed to recover a time stamp. The recovered time stamp is compared to a time reference. Decoding of data in the retrieved packet is controlled responsive to the comparison of the recovered time stamp to the time reference. Retrieval of the stored packet may include retrieving the stored packet from the buffer responsive to a preceding comparison of the time reference to a time stamp of a packet previously retrieved from the buffer. In further embodiments, controlling decoding of data in the retrieved packet responsive to the comparison of the recovered time stamp to the time reference may include foregoing decoding of the retrieved packet responsive to the time stamp indicating a time sufficiently before the time reference, decoding the retrieved packet responsive to the time stamp indicating a time sufficiently contemporaneous with the time reference or decoding and buffering the retrieved packet responsive to the time stamp indicating a time sufficiently after the time reference.

In additional embodiments of the present invention, a plurality of packets of a coded stream is stored in a buffer. Stored packets from the buffer are sequentially processed, wherein sequentially processing comprises sequentially retrieving packets from the buffer, parsing the respective retrieved packets to recover respective time stamps, comparing the respective recovered time stamps to a time reference and selectively decoding the respective retrieved packets responsive to the comparisons of the respective recovered time stamps to the time reference. Sequentially processing stored packets from the buffer may include retrieving a stored packet from the buffer responsive to a preceding comparison of the time reference to a time stamp of a packet previously retrieved from the buffer.

According to further embodiments of the present invention, an apparatus for processing packets of a coded stream includes a processor configured to sequentially retrieve respective packets from a buffer that holds a plurality of packets of the coded stream, to parse the respective retrieved packets to recover respective time stamps, to compare the respective recovered time stamps to a time reference, and to selectively decode the respective retrieved packets responsive to the comparisons of the respective recovered time stamps to the time reference. The processor may be configured to retrieve a stored packet from the buffer responsive to a preceding comparison of the time reference to a time stamp of a packet previously retrieved from the buffer.

Additional embodiments provide computer program products for processing packets of a coded stream. The computer program product includes computer program code embodied in a storage medium, the computer program code including program code configured to sequentially retrieve respective packets from a buffer that stores a plurality of packets of the coded stream, to parse the respective retrieved packets to recover respective time stamps, to compare the respective recovered time stamps to a time reference, and to selectively decode the respective retrieved packets responsive to the comparisons of the respective recovered time stamps to the time reference. The computer program code may include program code configured to retrieve a stored packet from the buffer responsive to a preceding comparison of the time reference to a time stamp of a packet previously retrieved from the buffer.

### BRIEF DESCRIPTION OF THE DRAWINGS

FIG. 1 is a schematic diagram illustrating a conventional MPEG receiver.

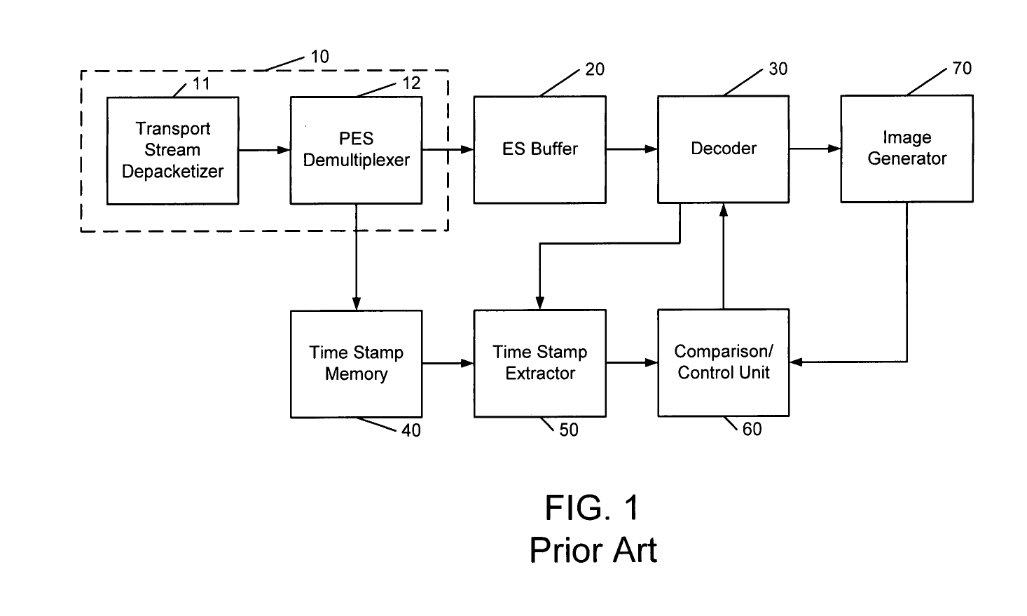

FIG. 2 is a schematic diagram illustrating time stamp storage and use in the receiver of FIG. 1

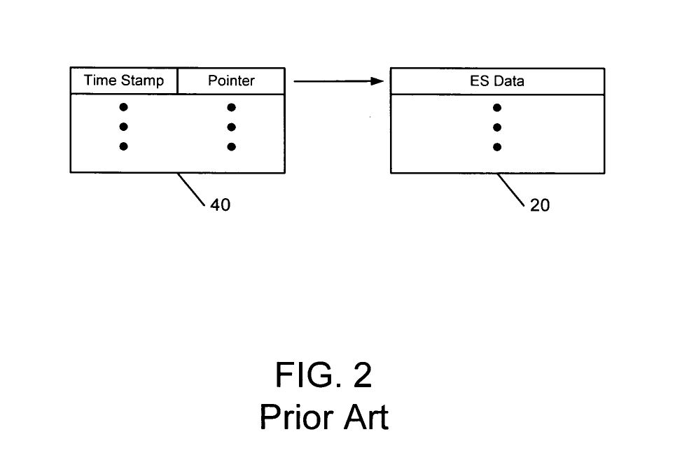

FIG. 3 is a schematic diagram illustrating an exemplary digital television system according to some embodiments of the present invention.

FIG. 4 is a schematic diagram illustrating a receiver and operations thereof according to some embodiments of the present invention.

FIG. 5 is a schematic diagram illustrating a synchronization unit of the receiver of FIG. 4 according to further embodiments of the present invention.

FIG. 6 is a flowchart illustrating exemplary packet processing operations of the receiver of FIG. 4 according to further embodiments of the present invention.

FIG. 7 is a schematic diagram illustrating a receiver and operations thereof according to some embodiments of the present invention.

FIG. 8 is a schematic diagram illustrating a synchronization unit of the receiver of FIG. 7 according to further embodiments of the present invention.

FIG. 9 is a flowchart illustrating exemplary decoding operations of the receiver of FIG. 7 according to further embodiments of the present invention.

### DETAILED DESCRIPTION OF EXEMPLARY EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, components may be exaggerated for clarity.

It will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, third etc. may be used herein to describe various elements, components and/or sections, these elements, components and/or sections should not be limited by these terms. These terms are only used to distinguish one element, component, or section from another element, region or section. Thus, a first element, component or section discussed below could be termed a second element, component or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the present invention are described herein with reference to block diagrams and flowchart illustrations, which support methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. Each block may represent a module, segment, or portion of code, which includes one or more executable instructions for implementing the specified logical function(s). It should also be noted that in other implementations, function(s) noted in the blocks may occur out of the order noted in the figures. For example, two blocks shown in succession may, in fact, be executed substantially concurrently or the blocks may sometimes be executed in the reverse order, depending on the functionality involved.

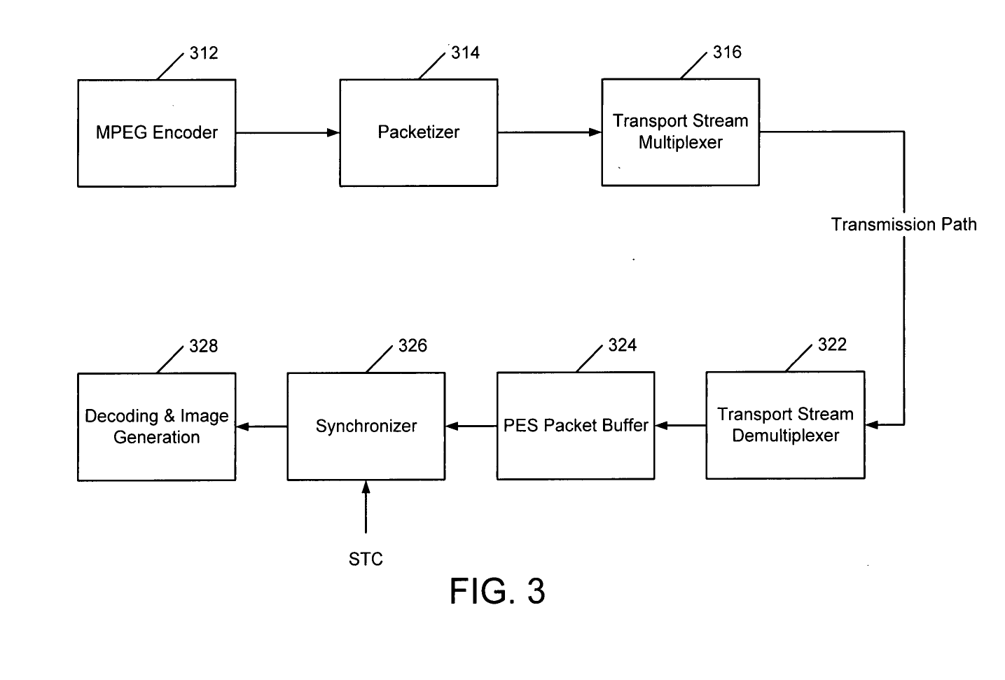

FIG. 3 illustrates an exemplary system for video encoding, transmission and decoding of, for example, a digital television (DTV) system, using a receiver structure and operations according to some embodiments of the present invention. An encoded video elementary stream ES produced by an MPEG encoder 312 is packetized in a packetizer 314 to produce a Packetized Elementary Stream PES. The Packetized Elementary Stream PES is multiplexed with other streams by a transport stream multiplexer 316 to produce a Transport Stream TS. Such operations are known to those skilled in the art, and will not be discussed in greater detail herein.

The Transport Stream TS is conveyed over a transmission path 315 to a transport stream demultiplexer 322, which may be located, for example, at a receiver. It will be appreciated that the transmission path 315 may include a variety of different components, e.g., mixers, transmitters, antennas, media transducers, downconverters, demodulators, and the like, as well as a communications medium, e.g., a wireless, wireline, or fiber optic transmission medium, or a recording medium, such as a magnetic, semiconductor or optical storage medium. The transport stream demultiplexer 322 demultiplexes the Transport Stream TS to recover a Packetized Elementary Stream PES′. Packets of the Packetized Elementary Stream PES′ are stored in a PES packet buffer 324. PES packets stored in the buffer 324 are sequentially retrieved by a synchronizer 326, which extracts video data therefrom and passed the video data to a decoding and image generation unit 328. The decoding and image generation unit 328 operates on the passed video data based on comparison of time stamps in the packets with a system time clock STC performed by the synchronizer 326.

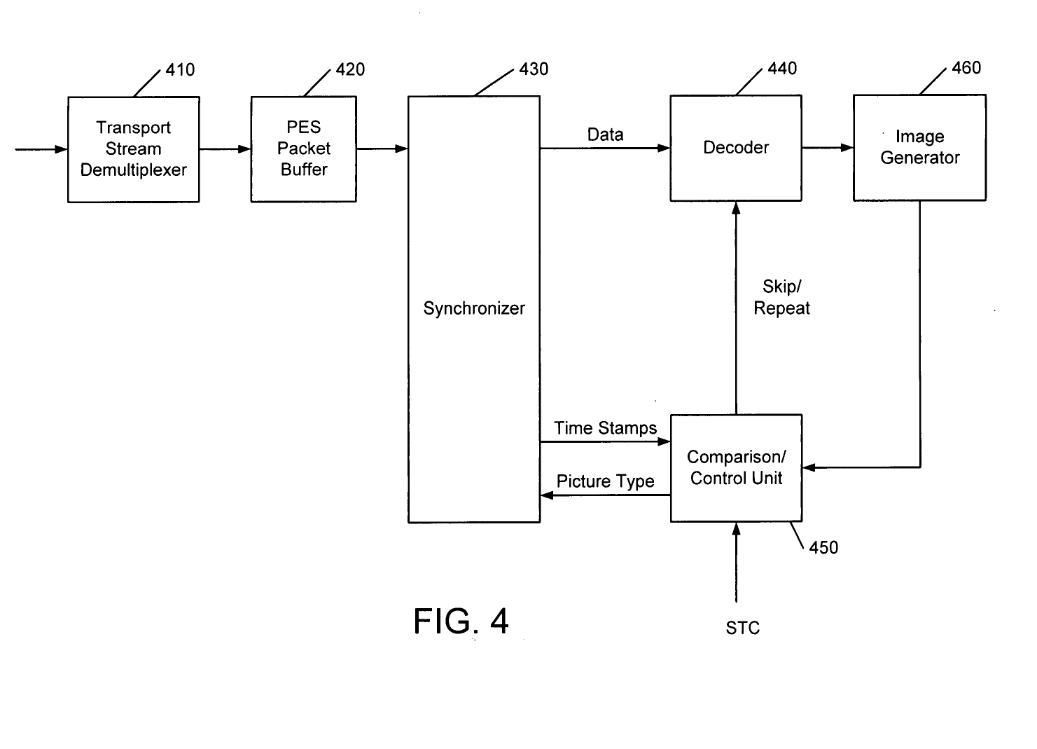

FIG. 4 illustrates an exemplary receiver 400 according to further embodiments of the present invention. The receiver 400 includes a transport stream demultiplexer 410 configured to demultiplex a Packetized Elementary Stream PES from a Transport Stream TS. A plurality of packets of the Packetized Elementary Stream PES is stored in a PES packet buffer 420. A synchronizer 430 sequentially retrieves packets from the PES packet buffer 420, extracts video data therefrom, and provides the extracted data to a decoder 440. The synchronizer 430 also extracts time stamps from the retrieved packets, and provides them to a comparison/control unit 450, which responsively generates a control signal for the decoder 440. The comparison/control circuit 450 compares the time stamps to a system time clock STC, and responsively generates a control signal provided to the decoder 440. In response to this control signal, the decoder 440 selectively decodes the payloads and provides decoded image data to an image generator 460.

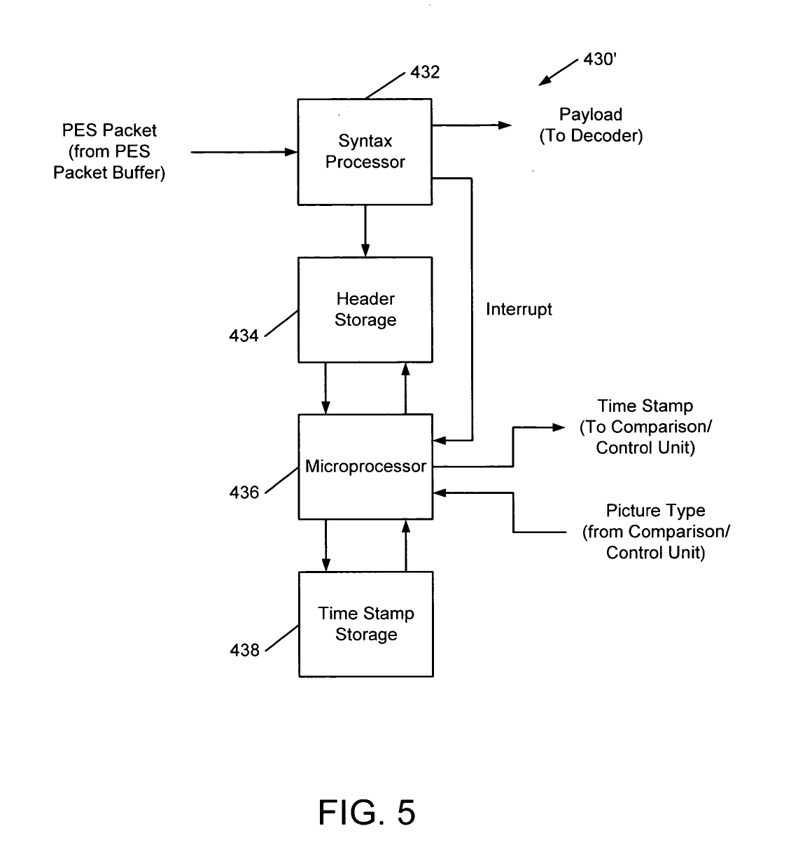

FIG. 5 illustrates an exemplary synchronizer 430′ which may be used in the receiver 400 of FIG. 4 according to some embodiments of the present invention. The synchronizer 430′ includes a syntax processor 432 that is configured to parse a PES packet retrieved from the PES packet buffer 420 to extract the header and payload thereof. The extracted header, including time stamp(s), is stored in a header storage memory 434. In concert with parsing of the PES packet, the syntax processor 432 generates an interrupt that is provided to a microprocessor 436. The microprocessor 436 is configured to responsively extract a time stamp(s) from a stored header in the header storage memory 434, to temporarily store the extracted time stamp(s) in a time stamp storage memory 438, and to transfer the stored time stamp to the comparison/control unit 450.

The time stamp provided to the comparison/control unit 450 (e.g., PTS or DTS) may be dependent on picture type. If bidirectional coding is disabled, i.e., no B-pictures are to be decoded, the microprocessor 436 may extract PTSs for I- and P-pictures and provide them to the comparison/control unit 450 for comparison with the system time clock. However, if bidirectional coding is active (i.e., if the Packetized Elementary Stream PES includes B-pictures), a P- or I-picture may have to be decoded some time before it is presented, so that it can act as a source of data for decoding of a B-picture. The DTS indicates the time when a picture should be decoded, whereas a presentation time stamp PTS indicates when it should be presented at the output of the decoder 440. Thus, for I- and P-pictures, a DTS and/or a PTS may be extracted by the synchronizer 430 and provided to the comparison/control unit 450 for comparison to the system time clock STC while, for B-pictures, a PTS may be extracted and provided to the comparison/control unit 450.

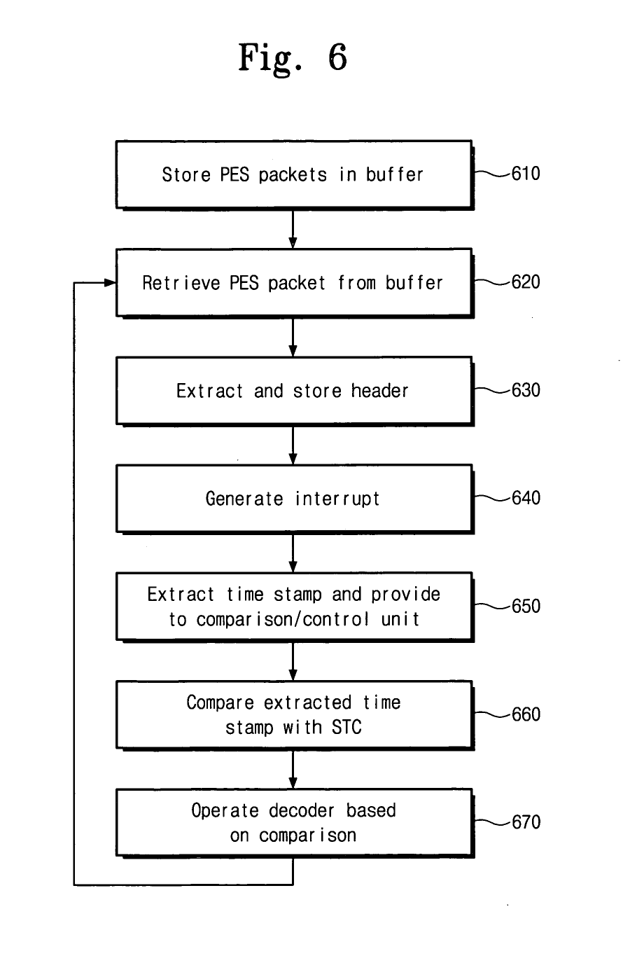

FIG. 6 illustrates exemplary decoding operations according to further embodiments of the present invention. Referring to FIG. 6 with continuing reference to FIGS. 4 and 5, a plurality of PES packets are stored in the PES packet buffer 420 (block 610). A PES packet is retrieved from the PES packet buffer 420 (block 620). The syntax processor 432 parses the retrieved packet, extracts header information and payload from the retrieved packet, stores the extracted header information in the header storage memory 434, and passes the extracted payload data to the decoder 440 (block 630). Responsive to the parsing, the syntax processor 432 generates an interrupt to the microprocessor 436 (block 640). The microprocessor 436 responsively retrieves the appropriate time stamp from the header storage memory 434, places it in the time stamp storage memory 438, and passes the time stamp on to the comparison/control unit 450 (block 650). The comparison/control unit 450 compares the time stamp with the system time clock STC (block 660) and responsively controls operation of the decoder 440 (e.g., decode, skip or repeat) based on the comparison (block 670). The syntax processor 432 may then retrieve a next packet in the buffer 420 (block 620) and similarly process this retrieved packet (blocks 630-670).

In some embodiments, the syntax processor 432 may retrieve packets from the PES packet buffer 420 in a first in/first out manner, e.g., by uniformly incrementing a buffer pointer for each packet retrieval. In further embodiments, a more complex buffer retrieval may be provided. In particular, results of the comparison (block 660) may be used for selective retrieval from the buffer 420. For example, if a comparison reveals that a packet retrieved from the buffer 420 is significantly “late,” a pointer used to access the PES packet buffer 420 may be significantly advanced to cause some packets in the PES packet buffer 420 to be skipped and allow the packet retrieval process to “catch up” with the system time clock STC. If a comparison reveals that a retrieved packed is significantly “early,” the pointer may be held at its current value, allowing the same packet to be re-retrieved and processed.

It will be appreciated that control of the decoder 440 by the comparison/control unit 450 may also occur in any of a number of different ways. For example, if the comparison of the time stamp and the system time clock reveals that the time stamp is sufficiently “later” the system time clock STC (e.g., the time stamp is sufficiently greater than the system time clock STC), the comparison/control unit 450 may instruct the decoder 440 to decode and buffer the data associated therewith and repeat presentation of a preceding picture to the image generator 460. In contrast, if the time stamp is sufficiently “earlier” than the system time clock STC (e.g., the time stamp is sufficiently less than the system time clock STC), the comparison/control unit 450 may instruct the decoder 440 to skip decoding (discard) the data associated with the time stamp. If the time stamp is substantially in agreement with the system time clock STC, the comparison/control unit 450 may instruct the decoder 440 to decode the associated data and present it to the image generator 460. A potential advantage of such an approach is that time stamps of buffered PES packets may be individually compared with the system time clock STC substantially contemporaneous with their parsing, which can avoid some of the problems associated with conventional techniques that buffer time stamps and search them for appropriate matches to the system time clock STC.

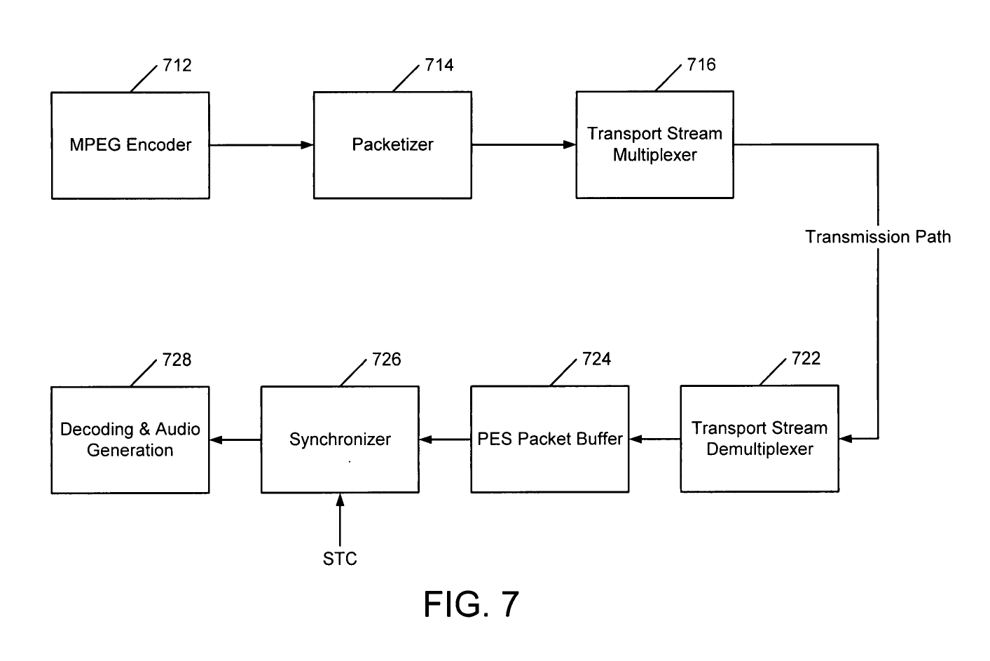

According to further embodiments of the present invention, a similar approach may be used on an audio stream. FIG. 7 illustrates an exemplary system for audio encoding, transmission and decoding using a receiver structure and operations according to some embodiments of the present invention. An encoded audio elementary stream ES produced by an MPEG encoder 712 is packetized in a packetizer 714 to produce a Packetized Elementary Stream PES. The Packetized Elementary Stream PES is multiplexed with other streams by a transport stream multiplexer 716 to produce a Transport Stream TS.

The Transport Stream TS is conveyed over a transmission path 715 to a transport stream demultiplexer 722, which may be located, for example, at a receiver device. It will be appreciated that the transmission path 715 may include a variety of different components, e.g., mixers, transmitters, antennas, media transducers, downconverters, demodulators, and the like, as well as a communications medium, e.g., a wireless, wireline, or fiber optic transmission medium, or a recording medium, such as a magnetic, semiconductor or optical storage medium. The transport stream demultiplexer 722 demultiplexes the Transport Stream TS to recover a Packetized Elementary Stream PES′. Packets of the Packetized Elementary Stream PES′ are stored in a PES packet buffer 724. PES packets stored in the buffer 724 are sequentially retrieved by a synchronizer 726 and audio data therefrom is passed to a decoding and audio generation unit 728, which decodes the audio data based on comparison of time stamps in the packets with a system time clock STC by the synchronizer 726.

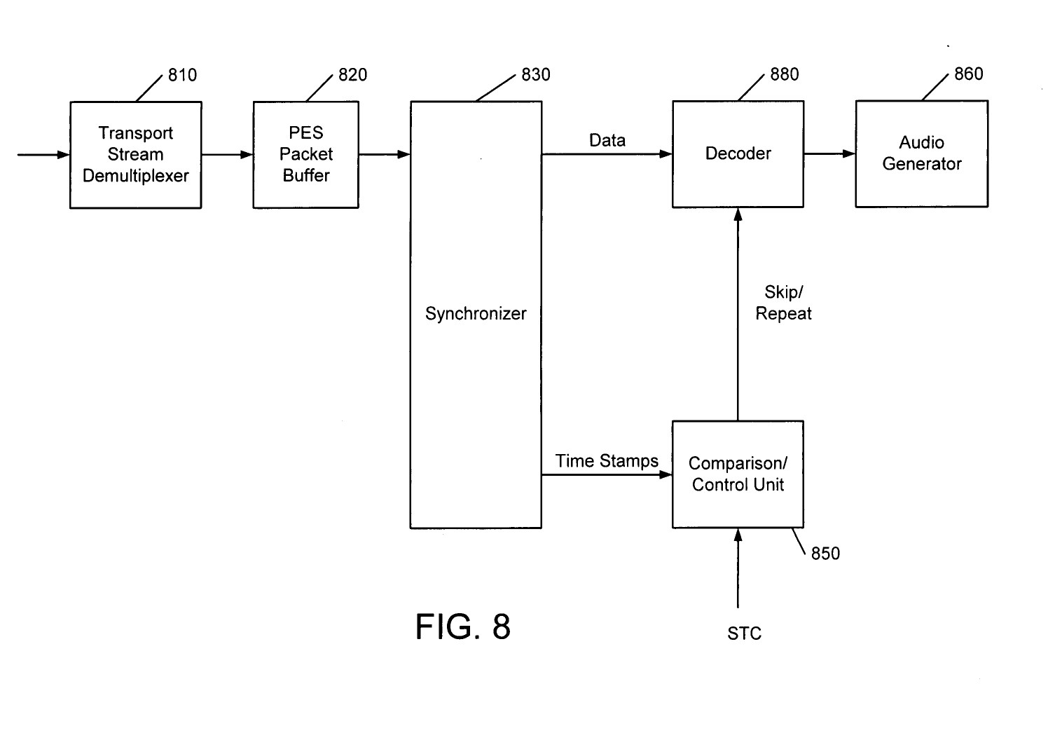

FIG. 8 illustrates an exemplary receiver 800 according to further embodiments of the present invention. The receiver 800 includes a transport stream demultiplexer 810 configured to demultiplex a Packetized Elementary Stream PES from a Transport Stream TS. A plurality of packets of the Packetized Elementary Stream PES is stored in a PES packet buffer 820. A synchronizer 830 retrieves packets from the PES packet buffer 820, extracts audio data payloads therefrom, and provides the extracted payloads to a decoder 840. The synchronizer 830 also extracts time stamps from the retrieved packets, and provides them to a comparison/control unit 850, which responsively generates a control signal for the decoder 840. The comparison/control circuit 850 compares the time stamps to a system time clock STC, and responsively generates a control signal provided to the decoder 840. In response to this control signal, the decoder 840 selectively decodes the payloads and provides decoded audio data to an audio generator 860.

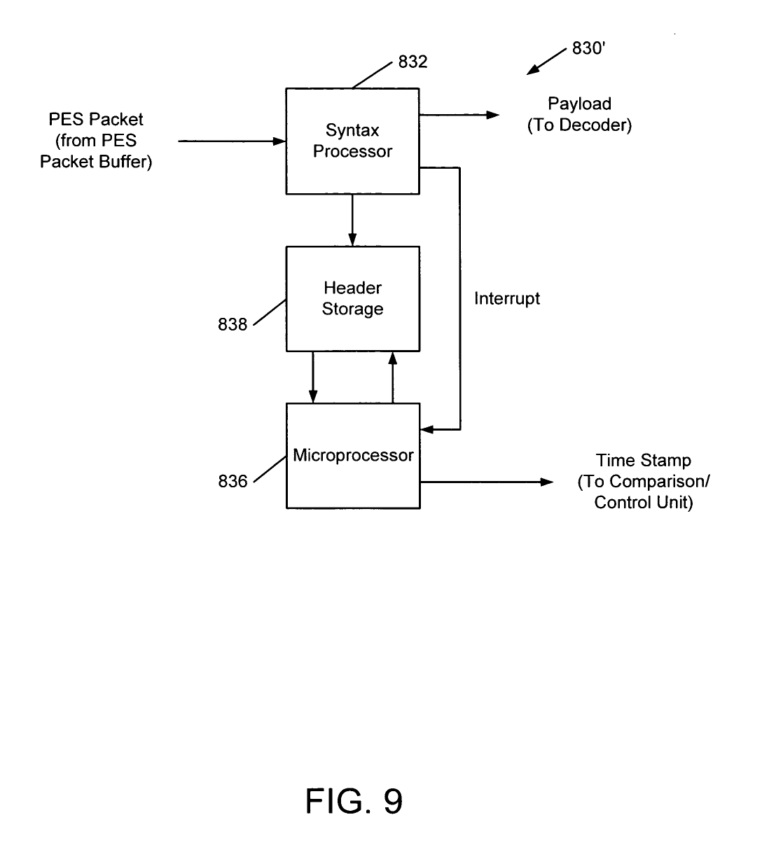

FIG. 9 illustrates an exemplary synchronizer 830′ which may be used in the receiver 800 of FIG. 8 according to some embodiments of the present invention. The synchronizer 830′ includes a syntax processor 832 that is configured to parse a PES packet retrieved from the PES packet buffer 820 to extract the header and payload therefrom. The extracted header, including time stamp(s), is stored in a header storage memory 834. In concert with parsing of the PES packet, the syntax processor 832 generates an interrupt that is provided to a microprocessor 836. The microprocessor 836 is configured to responsively extract a time stamp(s) from a stored header in the header storage memory 834, to temporarily store the extracted time stamp(s) in a time stamp storage memory 838, and to transfer the stored time stamp to the comparison/control unit 850. Unlike the synchronizer 430′ of FIG. 5, the audio synchronizer 830 need not need deal with ordering issues such as those associated with use of bidirectional coding in video transmission. Accordingly, the synchronizer 830′ operations may be simplified to passing only PTSs to the comparison/control unit 850. Skip and repeat operations along the lines discussed above may be used.

It will be appreciated that, in further embodiments of the present invention, decoding operations and apparatus along the lines described above may also be used for non-audio or video data that is carried in a Packetized Elementary Stream. It will be further appreciated that the present invention is also applicable to decoding of packetized streams from an MPEG Program Stream (PS) and, more generally, to packet communications according to standards other than MPEG-2

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. It is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method of processing a packetized coded stream, the method comprising:
storing a plurality of packets of the coded stream in a buffer;
retrieving a stored packet from the buffer;
parsing the retrieved packet to recover a time stamp;
comparing the recovered time stamp to a time reference; and
controlling decoding of data in the retrieved packet responsive to the comparison of the recovered time stamp to the time reference.

2. The method of claim 1 wherein retrieving a stored packet comprises retrieving the stored packet from the buffer responsive to a preceding comparison of the time reference to a time stamp of a packet previously retrieved from the buffer.

3. The method of claim 2, wherein retrieving the stored packet from the buffer responsive to a preceding comparison of the time reference to a time stamp of a packet previously retrieved from the buffer comprises controlling a pointer used to access the buffer responsive to a preceding comparison of the time reference to a time stamp of a packet previously retrieved from the buffer.

4. The method of claim 2, wherein retrieving the stored packet from the buffer responsive to a preceding comparison of the time reference to a time stamp of a packet previously retrieved from the buffer comprises re-retrieving the stored packet.

5. The method of claim 1, wherein controlling decoding of data in the retrieved packet responsive to the comparison of the recovered time stamp to the time reference comprises foregoing decoding of the retrieved packet responsive to the time stamp indicating a time sufficiently before the time reference.

6. The method of claim 1, wherein controlling decoding of data in the retrieved packet responsive to the comparison of the recovered time stamp to the time reference comprises decoding the retrieved packet responsive to the time stamp indicating a time sufficiently contemporaneous with the time reference.

7. The method of claim 1, wherein controlling decoding of data in the retrieved packet responsive to the comparison of the recovered time stamp to the time reference comprises decoding and buffering the retrieved packet responsive to the time stamp indicating a time sufficiently after the time reference.

8. The method of claim 1, wherein the coded data stream comprises a Packetized Elementary Stream (PES) and wherein the time reference comprises a system time clock (STC).

9. The method of claim 1, wherein the coded data stream comprises a video, audio and/or non-video or audio data stream.

10. A method of processing a packetized coded stream, the method comprising:
storing a plurality of packets of the coded stream in a buffer;
sequentially processing stored packets from the buffer, wherein sequentially processing comprises sequentially retrieving packets from the buffer, parsing the respective retrieved packets to recover respective time stamps, comparing the respective recovered time stamps to a time reference and selectively decoding the respective retrieved packets responsive to the comparisons of the respective recovered time stamps to the time reference.

11. The method of claim 10, wherein sequentially processing stored packets from the buffer comprises retrieving a stored packet from the buffer responsive to a preceding comparison of the time reference to a time stamp of a packet previously retrieved from the buffer.

12. The method of claim 11, wherein retrieving a stored packet from the buffer responsive to a preceding comparison of the time reference to a time stamp of a packet previously retrieved from the buffer comprises controlling a pointer used to access the buffer responsive to a preceding comparison of the time reference to a time stamp of a packet previously retrieved from the buffer.

13. The method of claim 10, wherein selectively decoding comprises foregoing decoding of a retrieved packet responsive to its time stamp indicating a time sufficiently before the time reference.

14. The method of claim 10, wherein selectively decoding comprises decoding a retrieved packet responsive to its time stamp indicating a time sufficiently contemporaneous with the time reference.

15. The method of claim 10, wherein selectively decoding comprises decoding and buffering the retrieved packet responsive to the time stamp indicating a time sufficiently after the time reference.

16. The method of claim 10, wherein sequentially retrieving respective packets from the buffer comprises re-retrieving a packet from the buffer responsive to its time stamp indicating a time sufficiently after the time reference.

17. The method of claim 10, wherein the coded data stream comprises a Packetized Elementary Stream (PES) and wherein the time reference comprises a system time clock (STC).

18. The method of claim 19, wherein the coded data stream comprises a video, audio and/or non-audio or video data stream.

19. An apparatus for processing a packetized coded stream, the apparatus comprising:
means for storing a plurality of packets of the coded stream in a buffer; and
means for sequentially retrieving respective packets from the buffer;
means for parsing the respective retrieved packets to recover respective time stamps;
means for comparing the respective recovered time stamps to a time reference; and
means for selectively decoding the respective retrieved packets responsive to the comparisons of the respective recovered time stamps to the time reference.

20. The apparatus of claim 19, wherein the means for sequentially retrieving comprises means for retrieving a stored packet from the buffer responsive to a preceding comparison of the time reference to a time stamp of a packet previously retrieved from the buffer.

21. The apparatus of claim 19, further comprising the buffer.

22. An apparatus for processing packets of a coded stream, the apparatus comprising:
a processor configured to sequentially retrieve respective packets from a buffer that holds a plurality of packets of the coded stream, to parse the respective retrieved packets to recover respective time stamps, to compare the respective recovered time stamps to a time reference, and to selectively decode the respective retrieved packets responsive to the comparisons of the respective recovered time stamps to the time reference.

23. The apparatus of claim 22, wherein the processor is configured to retrieve a stored packet from the buffer responsive to a preceding comparison of the time reference to a time stamp of a packet previously retrieved from the buffer.

24. The apparatus of claim 22, further comprising the buffer.

25. A computer program product for processing packets of a coded stream, the computer program product comprising computer program code embodied in a storage medium, the computer program code comprising:
program code configured to sequentially retrieve respective packets from a buffer that stores a plurality of packets of the coded stream, to parse the respective retrieved packets to recover respective time stamps, to compare the respective recovered time stamps to a time reference, and to selectively decode the respective retrieved packets responsive to the comparisons of the respective recovered time stamps to the time reference.

26. The computer program product of claim 25, wherein the computer program code comprises program code configured to retrieve a stored packet from the buffer responsive to a preceding comparison of the time reference to a time stamp of a packet previously retrieved from the buffer.
